(19) United States
(12) Patent Application Publication
(10) Pub. No.: US 2008/0190374 A1
(43) Pub. Date: Aug. 14, 2008

(54) WATER DISPENSER FOR PETS

(76) Inventor: Barry Lee Farris, Pollock Pines, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 12/027,224

(22) Filed: Feb. 6, 2008

Related U.S. Application Data
(60) Provisional application No. 60/899,912, filed on Feb. 6, 2007.
(60) Provisional application No. 60/900,851, filed on Feb. 11, 2007.
(60) Provisional application No. 60/921,584, filed on Apr. 1, 2007.
(60) Provisional application No. 60/961,963, filed on Jul. 24, 2007.

(51) Int. Cl. A01K 7/00

(52) U.S. Cl. 119/74

(57) ABSTRACT

An aseptic watering system for pets is that has a unique filtration and sterilization system for providing a source of drinking water substantially free of toxins, pathogens, resultant metabolic wastes, or other contaminants that may cause bothersome and life threatening diseases. The system also includes means for cooling the drinking water to make it more desirable to a pet.

### CROSS-REFERENCE TO RELATED APPLICATIONS

This application claims priority from U.S. provisional application Ser. No. 60/899,912 filed on Feb. 6, 2007, U.S. provisional application Ser. No. 60/900,851 filed on Feb. 11, 2007, U.S. provisional application Ser. No. 60/921,584 filed on Apr. 1, 2007, and U.S. provisional application Ser. No. 60/961,963 filed on Jul. 24, 2007, each of which is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to water dispensers, and more particularly to water purification and cooling systems for pets.

2. Description of Related Art

Animal or pet care has become an increasingly large industry. However, little has been done to remove pathogens and other contaminants from pet drinking water. Contaminants and/or pathogens may be inherent in the water supply, added to the water from airborne particles landing in the water, or introduced from one of the pets itself, e.g., from their oral cavity or contaminated or disease carrying hair from the pet falling into the water supply.

Most all sources of public or private water have an allowable amount of organisms that may become or already are pathogenic to humans or animals. Further, the air in an enclosed area such as a house often contains potential pathogens such as molds, mildew, bacteria and viruses and these airborne organisms tend to land on any horizon or vertical surface such as the water surface. Animals may also carry dry food from another bowl and deposit the dry food into the water supply, which can add pathogens to the water supply and also furnish a supply of nutrients for growing colonies of pathogens.

Viruses have been shown to remain active and potentially virulent for many hours or days after the virus was deposited on a surface and are capable of spreading into a body via the nose, eyes, mouth, lungs or a break in the skin. Once an organism enters the body, infection may occur, as well as damage to internal organs, particularly the kidneys, lungs and eyes. Viruses may also be a precursor to many lethal cancers. In cats, chronic or repeated exposure to certain pathogens has been linked to feline kidney failure. It has been shown that many breeds of cats have a genetic predisposition to kidney disease and accordingly, any reduction in biologic or inorganic materials is highly desirable.

The most common solution to provide a supply of drinking water to a pet generally comprises a simple bowl, pan, bucket or like device that can hold water, wherein the caretaker of the pet adds water to the container as needed. Other devices connect in fluid communication to a pressurized water supply, such as a spigot or garden hose, where the water is constantly running causing the container to frequently overflow. Some devices maintain a predetermined water level and open the water supply unit until the desired level is attained. Some devices allow a pet to perform an action that momentarily opens the pressurized water source so the pet can lick the water upon release of an actuator. Recently, various pet watering devices have been introduced that have an internal and submerged pump that lifts the water above the standing water level and allows the elevated water to flow back into the container so a fountain appearance is attained to give the illusion of a fresh and flowing water supply.

The above-described conventional animal watering devices have a number of drawbacks. First, none of the above-described devices effectively controls or minimizes the presence of contaminants/pathogens in the drinking water. Many of these devices provide stagnant or standing water, which is a perfect environment to promote the growth of any organism introduced into the water via the skin (including any hair or fur), respiratory tract, urinary system (e.g. spraying), ambient room air or from the oral cavity. As a result, these feeding devices often have problems with algae formation, mold, mildew, etc.

Another problem with existing products is the difficulty in maintaining cleanliness and/or cleaning surfaces used for retaining water. Inlets and outlets to these water-retaining receptacles often have surfaces that are difficult to reach for cleaning. In addition, the construction and/or materials (e.g. plastics) are not conducive for being washed or cleaned in water hot enough to kill pathogens without deforming or destroying the container, and/or are not dishwasher compatible.

The materials used for constructing existing device designs may also retain heat and therefore keep the water at a higher than desirable temperature. These higher temperatures reduce the desirability of an animal to drink. Animals generally should drink large amounts of water to keep their organ systems healthy. For example, water intake is helpful to allow the liver and kidney's to adequately flush and excrete undesirable metabolites, pathogens and other undesirable chemicals and compounds.

Furthermore, such materials may attract and retain substances that make the water undesirable to the animals and therefore reduce the amount of water that the animal might otherwise drink, or become etched and support bacterial or other growth. Because the water retaining portions of existing systems are contiguous with the body of the device, they tend to be constructed of lightweight materials that subject the device to spilling or being tipped over. In addition, water-retaining receptacles that are manufactured out of plastic may result are known to expel contaminants from both the plastic and colorants contained therein.

Where existing systems have filters, such filters are often hidden from plain site, thus making it difficult to determine or visualize when that filter is clogged and in need of exchange.

In existing systems employing pumps for circulation of water, such pumps are in free communication with the retained water, leaving the pumps susceptible to debris buildup and failure.

Therefore, an object of the present invention is to provide a source of drinking water is substantially free of toxins and pathogens and the resultant metabolic wastes that causes bothersome, expensive, and life threatening diseases.

Another object of the present invention is to provide a cool source of drinking water to encourage adequate hydration of the animal and inhibit growth of pathogens.

Another object of the present invention is to provide a source of drinking water that is dispensed in a fashion that attracts pets to drink from the source of water.

At least some of these objectives will be met in the description detailed below.

### BRIEF SUMMARY OF THE INVENTION

The present invention relates generally to animal watering stations and more specifically to an aseptic watering station for pets that provides a source of drinking water substantially free of toxins, pathogens, resultant metabolic wastes, or other contaminants that may cause bothersome, expensive, and life threatening diseases. The present invention is also configured to keep the water at a cooler temperature to encourage adequate hydration of the animal.

An aspect of the invention is a pet watering station having a basin configured to hold a volume of drinking water, a pump in fluid communication with the basin via an intake, and a sterilization unit in fluid communication with the pump. The sterilization unit is configured to kill organisms in the water. The watering station also includes one or more filters coupled to the sterilization unit and pump to screen particles from the water, and an outlet disposed above the basin for directing the filtered and sterilized water into the basin. Silver ions, silver compounds or similar anti-bacterial agents may also be added to the charcoal in the filter to kill pathogens that are in the water. The antimicrobial substances may be included in the filtering substrate, such as silver inside the carbon matrix.

In one embodiment, the basin comprises a bowl-shaped receptacle having elevated sidewalls that cool the basin via surface-water evaporation. Preferably, the watering system also includes a base configured to house the basin, pump and sterilization unit. The basin is configured to be detachably removed from the base so that it may be readily cleaned or placed in a dishwasher for cleaning. In another embodiment, the sidewalls of the basin terminate at a lip formed around the circumference of the basin, so that the lip can rest above an opening in the base and be suspended within the base. The basin may also comprise an uninterrupted inner surface that facilitates cleaning and manufacturing.

In one embodiment, a series and/or system of materials may be inserted between the exterior bottom of the basin and extending to the floor, to provide additional cooling when the temperature of the floor is less than the ambient room temperature, e.g., to function as a heat-sink when the temperature of the floor is less than the ambient air temperature.

The watering system may also include an intake filter at or near the intake to screen the water from particulates prior to the water entering the pump. The intake filter not only serves to protect the pump from failure, but functions to keep the plastic or glass interface of the downstream UV sterilization unit clean to maintain the “kill rate” of the UV unit and also prevent particulate matter from shielding a pathogen from the UV light.

In a preferred embodiment, an elevated container is supported above the basin. The elevated container configured to retain a volume of water, wherein the outlet is directed into the elevated container to at least partially fill the elevated container with water. The container has a spout or nozzle located near the bottom surface of the elevated container and is configured to direct water into the basin according to the idiosyncrasies of the pet and/or pet owner.

In one embodiment, the elevated container comprises a porous material that absorbs water from an inside surface of the container to cool the container, thereby cooling the water.

In a preferred embodiment, the elevated container is configured to house the filter at a location toward the bottom surface of the container so that water entering from the outlet passes through the filter before exiting out the spout. The spout is adjustable to vary the direction and rate of water entering the basin. The container may also be configured to house or be coupled directly to a sterilization means, such as a UV sterilization unit.

In another preferred embodiment, the sterilizer comprises a UV lamp configured to direct UV light at water distributed from said pump. Other sterilization means, such as ozone, antimicrobial solutions, etc. may also be employed. In one embodiment, the basin comprises an inner surface coated with an antimicrobial solution that is configured to sterilize said water.

Another aspect is a method for providing drinking water to an animal or pet. The method includes the steps of dispensing a volume of water in a basin configured to retain the water, displacing at least a portion of the volume of water out of the pump via an intake line, sterilizing the water and redirecting the water into the basin.

Preferably, the method also includes filtering particulates from the water. Filtering may be performed at the intake and/or after said sterilization of the water.

In one embodiment, generating a negative pressure at the intake via a pump in communication with the intake displaces the water.

In another embodiment, the method further includes elevating the water to a container above the basin, filtering the water as it passes through the container, and directing the water into the basin via a spout in the container. The spout is preferably adjustable so that it can be manipulated to change the direction or flow of water into the basin, e.g. a jet or stream of water into the basin, or a drip or water into the basin, or to cause currents in the water so as to minimize “dead spots” in the bowl that may harbor deleterious organisms or particulate matter.

The method also includes the steps of cooling the volume of water retained in said basin. In a preferred embodiment, the water is cooled from evaporative cooling of the basin and/or elevated container.

Another aspect is a system for providing drinking water to animals having a basin configured to hold a volume of drinking water, a water treatment module configured to treat the volume of water for consumption and circulate said water in and out of said basin, and a base configured to house the water treatment module and basin, wherein said basin is detachably received on said base.

The water treatment module or unit preferably has a sterilization unit configured to kill organisms present in the volume of water, e.g., a UV lamp configured to direct UV light at water distributed from said pump. The water treatment module may also have a pump coupled to the sterilization unit to draw water in from an intake at the basin and circulate the water between the basin and the sterilization unit. The water treatment module may also include a filtration unit coupled to the pump and the sterilization unit to filter particulates from the volume of water. The filtration unit may include an intake filter at or near the intake that screens particulates from the water prior to entering the pump, and/or a filter following the sterilization unit, pump, or other location.

In one embodiment of the current aspect, an elevated container is supported above the basin. The elevated container configured to support a volume of water supplied from the water treatment module to at least partially fill the elevated container with water. A spout is located near the bottom surface of the elevated container to direct water into the basin.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a perspective view of a pet watering system in accordance with the present invention.

FIG. 2 is front perspective view of the watering system of FIG. 1 with the watering basin removed.

FIG. 3 is a section view of the watering system of FIG. 1.

FIG. 4 is a side view of an alternative basin and filter configuration of the watering system of the present invention.

FIG. 5 is a side view of another alternative basin and filter configuration of the watering system of the present invention.

FIG. 6 is a side view of an alternative watering system of the present invention.

FIG. 7 is a side view of an alternative elevated container for the watering system of the present invention.

FIG. 8 is a side view of an alternative watering system of the present invention.

FIG. 9 is a top view of the watering system of FIG. 8.

FIG. 10 is an alternative configuration of the watering system of FIG. 8.

FIG. 11 illustrates a schematic diagram of a filter overflow setup in accordance with the present invention.

### DETAILED DESCRIPTION OF THE INVENTION

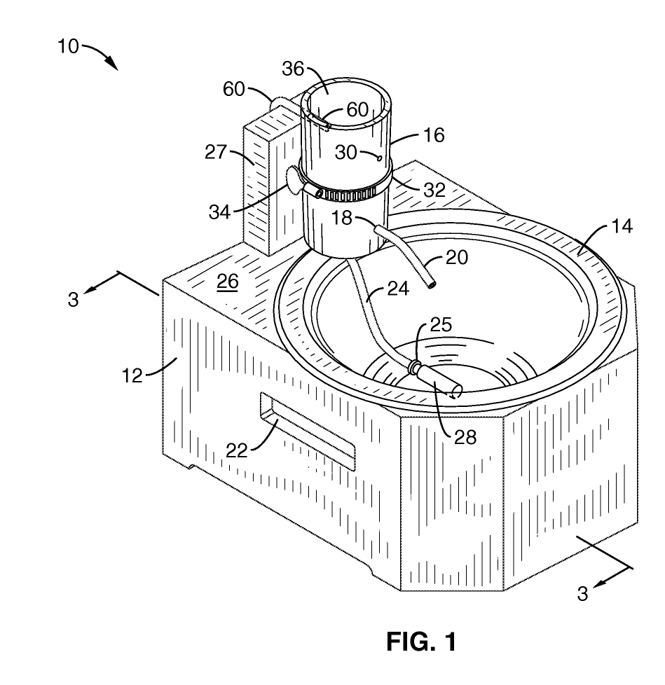

Referring more specifically to the drawings, for illustrative purposes the present invention is embodied in the apparatus generally shown in FIG. 1 through FIG. 11. It will be appreciated that the apparatus may vary as to configuration and as to details of the parts, and that the method may vary as to the specific steps and sequence, without departing from the basic concepts as disclosed herein.

FIGS. 1-3 illustrate a pet watering system 10 in accordance with the present invention. Watering system 10 comprises a base or cabinet 12 that is configured to support a basin 14. The cabinet may be constructed of wood, plastic, or other polymer strong enough to support the weight of the basin 14 and water. As shown in FIG. 1, the basin 14 is generally a bowl-shaped receptacle configured to retain a volume of water for consumption by an animal or pet. The basin 14 comprises a symmetric shape and large opening that facilitates cleaning and evaporative cooling.

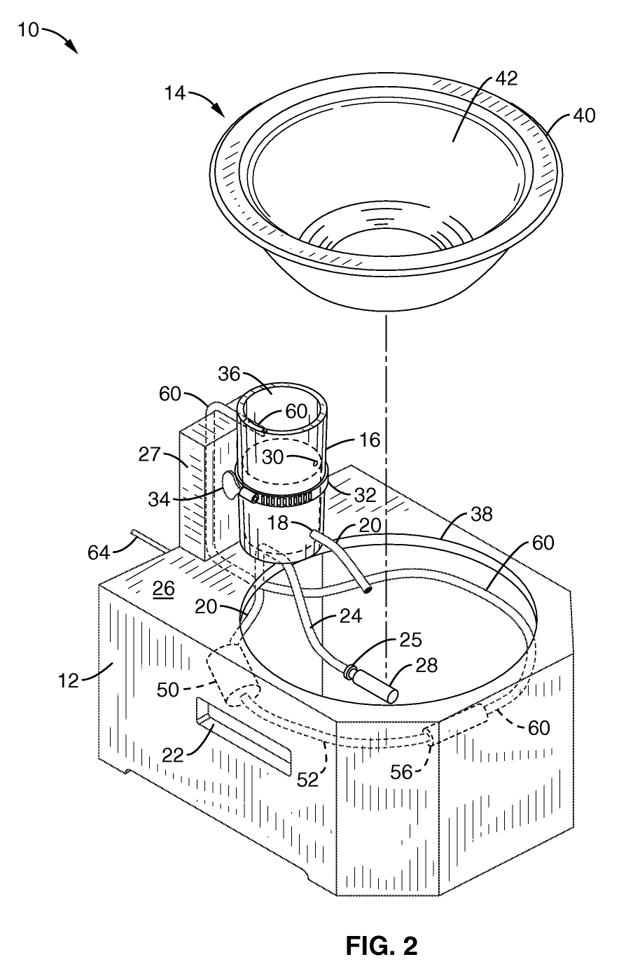

Referring to FIG. 2, the basin 14 is shaped to have fairly deep walls that terminate in a lip 40 that rests over a cutout 38 of the top surface 26 of cabinet 12. In this configuration, the basin 14 may be readily removed from the cabinet 12 to allow access to the cavity 44 and the contents therein, or to allow the basin 14 to be separately cleaned. The cabinet 12 has an upper panel 26 that may be removed to add further access into the cavity 44. The side panels of the cabinet 26 have cutouts 22 that serve as handles for moving the system 10, and allow ventilation to keep the cavity 44 cool.

In a preferred embodiment, the cabinet walls are fairly high to allow the basin 14 to be suspended within cavity 44. The generally deep sidewalls of the basin 14 not only provide for a larger volume of water, but also allow cooling of the water via evaporation.

Watering system 10 is preferably configured with sterilization and purification means to keep the water in basin 14 substantially free of contaminants, particulates and/or pathogens. Water is first extracted from basin 14 via intake tube 24 that draws the water to the other elements of the system (e.g. from negative pressure caused by a pump or differences in elevation relative to the water level of the bowl).

The distal end of intake tube 24 is preferably configured to have an intake filter 28. Intake filter 28 may be any number of replaceable filters configured to screen particulates (e.g. hair, dust, debris) from the basin water that would be deleterious to the operation of downstream elements. In one configuration, the intake filter 28 comprises high-density cylindrical foam that is attached to intake tube 24 via a coupling 25.

In one configuration, the intake filter 28 comprises a material and/or color that provides visual indication of the condition of the filter. For example, the filter 28 may comprise a white or light colored foam that darkens as particulates are screened from the water. When the filter 28 has turned dark grey or black, it serves as an indicator to the user that the filter 28 may need replacement.

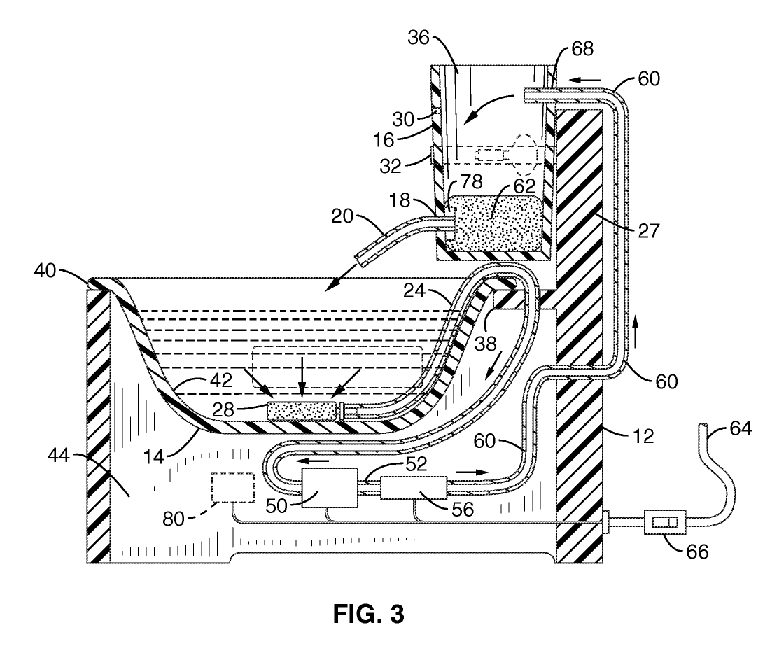

As shown in FIG. 3, the intake tube 24 is configured to pass up and over the basin 14 and into the cabinet 12, or alternatively into a pump that is located in the structure 27. This configuration allows the basin to be uninterrupted, which is preferred for ease of removing the basin 14, and for cleaning the basin. The absence of a through hole in the basin 14 prevents the occurrence of surfaces that are difficult to reach and therefore inhibit bacterial growth or the like.

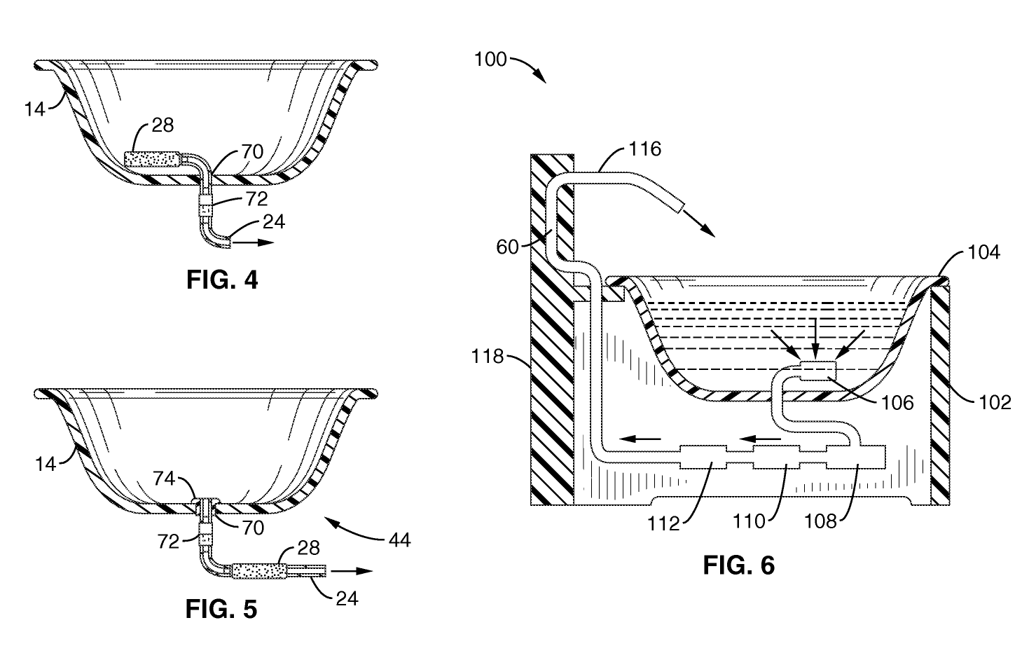

In an alternative embodiment shown in FIG. 4, basin 14 may be configured with a through hole 70 so that intake tube 24 may pass through the bottom of the basin 14. This configuration may be used where aesthetics are desired. A coupling 72 may be provided (e.g. a quick release, or threaded attachment) to allow the basin 14 to be separated from the remainder of the system.

In another alternative embodiment shown in FIG. 5, the intake filter 28 may be positioned under the basin 14 in the cavity 44 of cabinet 12. This configuration may be desirable for additional aesthetics, and for pets that tend to disturb the filter while visible in the basin 14. Seal 74 may be provided around through-hole 70 to ensure water does not leak into the cabinet 12. The placement of filter 28 inside cabinet may also be implemented similarly in the non-interrupted basin configuration shown in FIG. 4.

Referring back to FIGS. 2 and 3, intake line 24 is coupled to a pump 50. Pump 50 is configured to be strong enough to draw water through the various elements and filters in the system, while being relatively quiet in operation so as to minimize annoyance to either pets or those in close vicinity to the system. The pump 50 may also be insulated to further dampen noise produced by its operation.

The pump 50 pushes water through connecting line 52 to a sterilization unit 56. The sterilization unit 56, described in further detail below, is configured to substantially eradicate living organisms that may be present in the water.

During transportation of the system 10 or replacement of filters or the basin, lines 24 and 60 may be provided with a shut-off valve or clamp to retain the water within the pump 50 and sterilization unit 56. This allows the pump and sterilization unit to always maintain a level of water so that they are not subject to a dry start when started up.

As illustrated in FIG. 3, a GFI protected electrical cord 64 delivers power to the various components such as the pump 50, sterilizer 56, lighting, optional cooling unit 80 or any other device that requires electricity. The cord 64 preferably has a switch 66 that allows the user to power the system 10 on and off.

The water than passes along outlet line 60 and up the cabinet 12 (under pressure provided by pump 50) to elevated container 16. The elevated container 16 is configured to generate a stream of filtered and purified water back into the basin 14. Container 16 is elevated above the basin 14 and retained by vertical support 27 that extends above the top surface 26 of the cabinet. A flexible band 32 with tightening means 34 may be used to stabilize and hold the elevated container 16 to the vertical support 27, and is generally adjustable to lock in the canister when desired.

Container 16 has an opening 36 at its top and is configured to retain one or more filter elements 62 (e.g. charcoal or similar filtering means) and/or a filter containing an antimicrobial substance, and accepts water from outlet line 60 at the top of the container. Outlet line 60 may enter the container 16 through opening 68, or may pass over the top of the container and pour into opening 36. Although FIG. 3 shows output line 60 passing out of the rear panel of cabinet 12 and over support 27 to container 16, it is appreciated that line 60 may be routed a number of different ways. For example, line 60 may be routed through support 27 or upper panel 26 and into container 16.

The water exiting out of line 60 then drains into elevated container 16 to at least partially fill the container. As water fills the container 16, gravity tends to push the water through the cylindrical (or other shape to generally match the shape of the container) filter 62 toward the bottom of the container.

Elevated slightly higher than the bottom surface of the container 16 is a port 18 having a nozzle or spout 20 protruding there through to direct water into the basin 14. Nozzle 20 preferably comprises is a straight or curved elastic tube of plastic or other inert material that is configured to be pliable to bend to different angles to change the direction and/or flow characteristics of the water entering the basin. Nozzle 20 may also direct the stream of water to enhance, diminish or retard the noise and splashing from the water entering the bowl. The nozzle 20 may also have an additional filter 78 to collect dust and other particulate matter from the charcoal filter 62 and other sources.

If and when the filter 62 becomes clogged with debris, water will tend to drain out nozzle 20 at a slower rate than is input from output line 60. This will generally cause the water level to rise. Overflow port 30 is located at the upper and frontal end of the container 16 and allows the water to drain into the basin in such case either filter 62, 78 or nozzle 20 is clogged. Such occurrence will also serve to indicate to the user that a filter is occluded and in need of replacement.

FIG. 6 illustrates an alternative pet watering system 100 having a filter 112 directly following sterilization unit 110 within cabinet 102. In system 100, water from bowl 104 enters line 24 through intake filter 106 that is located at the bottom of the bowl. Pressure from pump 108 draws the water into the sterilization unit and through the filter 112, and is then driven up tube 60 to outlet 116 where it streams back into the bowl 104. Because the filter 112 is located within the cabinet 102, no elevated container, as shown FIGS. 1-3, is required. However, an elevated container may still be implemented via support 118 to provide additional cooling and/or water manipulation characteristics. FIG. 6 illustrates line 24 running through the bowl 104 prior to reaching pump 108. However, it is appreciated that bowl 104 may be uninterrupted as well, with line 24 running up and over bowl and into cabinet 102 to meet up with the pumps intake. In addition, filter 106 may be positioned within cabinet 102.

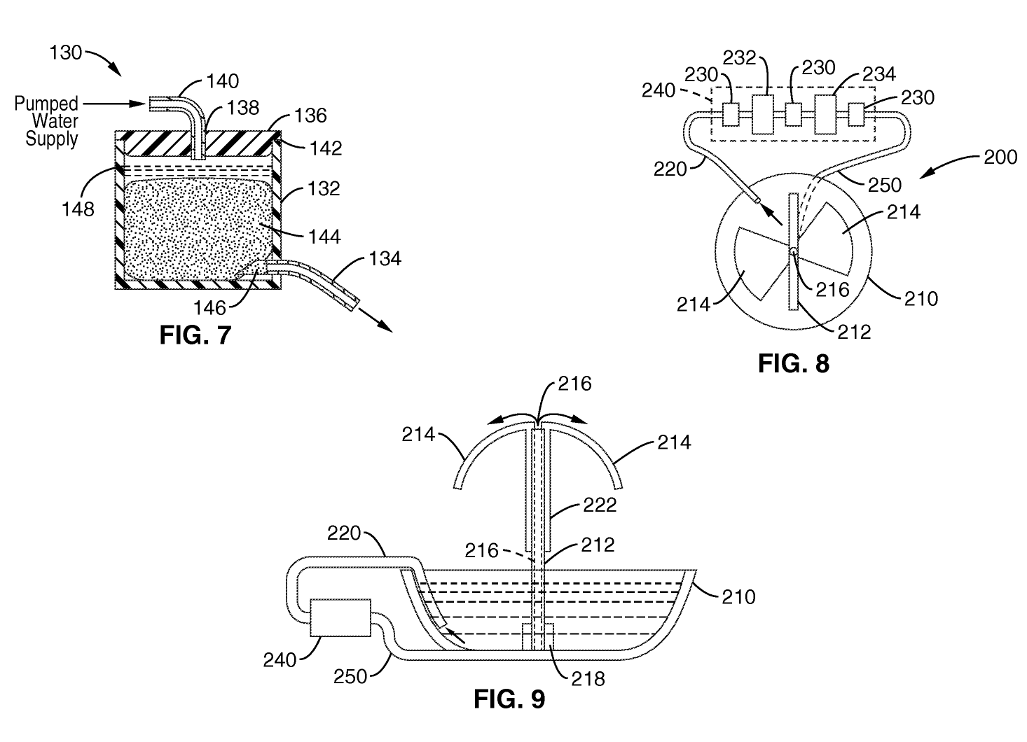

FIG. 7 illustrates another alternative embodiment of a watering system 100 showing an elevated container 132 with cap 136. In this configuration, cap 136 is positioned on the upper end of container 132 to form a seal at 142. Water enters the container 132 via output tube 140, which passes through opening 138 in cap 136. As water enters the container 132, it travels downward through filter bag 144 to exit out spout 134. A secondary filter 146 may be positioned at the entrance of spout 134 to filter any debris (e.g. charcoal) from the filter 144. Spout 134 is preferably bendable to alter the angle of water entry into the basin.

The entry hole 138 in cap 136 may also be oversized such that water seeps through the hole and either drips or streams down the outside of container 132 to add additional water dispensing into the basin.

The cap 136 is configured to fit snugly into container 132 so as to resist a small amount of water pressure from water level 148 rising. However, if the water level 148 rises at a rapid rate so as to increase pressure, the cap 135 is configured to pop out of the container, indicating to the user that one of the filters 144, 146 needs replacement.

The container 132 may also be composed of a clear substance, e.g., glass, that promotes visibility of the filter 144, so that the user has indication of the filter's condition.

The all of the embodiments disclosed heretofore and below are configured to provide sterilization of the drinking water via one of, or a combination of, several different modalities. In a preferred embodiment, the sterilization unit (56, 110) comprises a UV a lamp that emits ultra violet radiation in a spectrum that is germicidal. Preferably the lamp is not in direct contact with the water, e.g. the lamp is positioned inside of a highly clear tube, such as glass, that will allow the maximum amount of UV light to pass through the glass and sterilize the water that is circulating around the UV light-emitting source. Preferably, the sterilization unit (56, 110) generates ultraviolet light in the range of approximately 100 nm to approximately 315 nm, which is generally lethal to most organisms within defined exposure times. The UV light kills organisms by destroying essential functions of the pathogen. There are no chemicals involved in the kill rate and there is no resistance potential to the light.

The UV sterilizer 56 be may configured to treat water that has been elevated above the UV sterilizer 56, with the water entering the UV sterilizer 56 due to the influence of gravity.

The sterilization unit (56, 110) may be located outside of the cabinet 12 or a UV lamp could be inside the cabinet 12 or container 16, but preferably has some shielding to block the light so as not to be viewed by any animal or human. In one embodiment, the unit may have an indicator (not shown), such as a light or series of lights that indicate the status and operation of the UV unit. Such indicator would be visible to the user and would inform the user the status of the sterilization unit (56, 110), e.g. whether the bulb is working or needs to be replaced.

The sterilization unit (56, 110) may also comprise any one, or a combination of the following: ozone, nanofiltration, nanoheating, magnetic fields, electrolysis, chemical scavenging compounds, silver ions, or other ions that have an acceptable risk/benefit ratio, or filter capable of removing objects smaller than 0.2 microns. For example, the inside surface 42 of the basin 14, or of container 16, may be coated with an antimicrobial coating, e.g. micronized silver in an oil-based substrate. This coating may be used in lieu of, or in combination with, UV sterilization unit 56.

The present invention is also configured to use one or more filters to remove foreign material and organisms from the flow of water. The filters may be located in between various components, such as upstream from the basin 14, the pump 50, and the sterilization unit 56, and downstream from the sterilization unit 56. The filters used in the present invention have various functions depending on the location of the filter, e.g. purifying water or as being protective of the pump and or sterilization unit 56, or additional units such as a refrigerating unit.

One region having a particular need for filtration is between the outflow from the basin 14 and the pump 50. A set of set of macro filters may be employed at this area to filter out any large objects such as pet hair that might damage the pump or reduce the efficiency of the pump. In a preferred embodiment, this intake filter needs is configured to be easily replaced while also being easily viewed to ascertain if the filter needs to be cleaned or replaced.

Another single filter or set of filters may be used between the pump 50 and the sterilization unit 56 to filter out micro objects (see also FIG. 8 below). This would have the tendency to improve the performance of the sterilization unit 56, particularly the UV sterilizer, which is most effective when there are few objects to potentially block the UV light from a pathogen. Another filter may be provided prior to the water entering into the sterilizing unit 56 is a filter that prevents oxygen and perhaps other gases from entering the sterilizing unit 56, as pathogens can be shielded from the UV light by a molecule of a gas in the solution being passed through the UV sterilizer.

Downstream from the sterilization unit 56 and before the water enters the basin 14 it may be desirable to have an additional filter, e.g. an ultra small filter such as a 0.2 micron filter to filter out debris from the destruction of organisms killed by the UV light as the UV light can explode the cell of an organism and the debris from the dead cells can be toxic or harmful to an animal.

The filter 62 in container 16 may also contain other filtering media, either natural or synthetic, and be in response to the different characteristics of the water in a particular geographic or geological location or also contain substances that can buffer or moderate the pH of the water before the water leaves the canister. The filter 62 could also contain a substance that is desired and would attract otherwise timid animals, such as catnip. The filter 62 may also contain beneficial water-soluble chemicals such as potassium should a veterinarian recommend.

One or more filters may also be added to remove any undesirable parts of the water that reduce its desirability such as objectionable smell or taste, lack of clarity or other characteristic of the water that causes the animal to reduce the optimal intake of water or even refuse to drink at all. For example, additional filters that may be added to neutralize or normalize the pH or other properties used, or to trap certain common impurities in water, e.g., carbon. A device may be implemented, as available in the art, to add oxygen into the stream of water downstream from the sterilizing unit to support the normal chemistry of the water supply such as in a buffering situation allowing the desirable physical properties of water to be present which will increase the amount of water needed and desired by an animal.

The present invention is further configured with one or more elements to provide cooling of the water available in the basin 14. For example, the basin (14, 104), the elevated container (16, 132), or both may be shaped and composed of materials that facilitate cooling. For example, either the basin (14, 104), the elevated container (16, 132) may comprise a material such as porous clay or ceramic to cool the water contained in the watering area. The porous material may be used to cool the water that is enclosed by the material due to the water seeping through the porous material and then being evaporated, thereby cooling the water in the matrix of the material and in turn cooling the water inside the structure formed by the material. The temperature most often contours the amount of water that seeps through the material during the firing phase of manufacture of the water station container.

Furthermore, the walls of the basin 14 and elevated container 12 may be oversized and steep to add additional surface area, furthering evaporation and cooling effect. The basin 14 may also be made of a dense material that could be removed and put into a refrigerator or freezer so that the water temperature of the water within the well could be cooled for many hours, especially if two basins were available and periodically traded out. The porosity can also be controlled or isolated by coating a portion of a surface of a material such as an oil based product which effectively seals the material and prevents water from passing through the material, thus preventing the water from passing through and being available for evaporation. The porous material can be of a natural or synthetic clay source or a wood source or any number of products that will allow a small amount of water to pass through the material and thereby be available for evaporation and the positive and healthy benefits of cool water being made accessible for a pet or other animal to drink.

In some embodiments, a cooling unit 80 (see FIG. 3), such as a fan, refrigeration unit, or like device, may be placed in the cabinet 12 to cool the bowl 14 and water contained therein.

The tubing 24, 52, 60, 220, 250 provides for the movement of water without leaking or sweating and also provides for the movement of heat from the water inside the tube, thus promoting the transfer of unwanted heat to the ambient air. A material such as copper might be used if dissipation of heat from the tube to the room air is desired. The tubing will preferably not promote the growth of organisms and may be rigid or flexible as well as allowing for easy removal for cleaning or replacement. Where appropriate, the tubing can also be insulated to prevent heat from being released into the environment when the ambient room temperatures are below the desired temperatures for the water while also having the desired effect to provide heat to prevent freezing. The tubing may also contain or comprise various substances to inhibit the growth of pathogen, e.g. by coating both or either outside and inside surfaces of the tubing, or the material used to manufacture the tubing could have various chemicals to kill pathogens or limit growth of a pathogen and prevent the existence or growth of biofilms.

The bore size of the tubing (e.g. tubing 52) tubing 24 may also be varied to increase or decrease the flow rate and therefore the amount of time that the flow is exposed to the UV light by unit 56.

FIGS. 8 and 9 illustrate an alternative pet watering system 200. System 200 comprises a basin 210 configured for holding a volume of water for feeding an animal or pet. The basin 210 may comprise any number of materials and be configured for cooling as described in the embodiments above. Water in the basin is pumped out via intake tubing 220 to a water treatment unit 240 for sterilization and filtering. The treated water is then directed through outlet tubing 250 to a centrally located pedestal 216 where the water is fed vertically upward to drip or flow downward back into the basin 210.

Water exits from pedestal 216 and travels down either two rectangular columns 212 or dome 214. The dome 214 rests at the top of the pedestal 216, and functions to offer different water dispersion forms configured to interest an animal to drink. Dome 214 comprises of two somewhat pie-shaped, curves surfaces that direct water coming out of the top of the pedestal 216 to flow down the dome 214 surfaces and generate a sheet of water that falls into the basin 210. On either side of the pedestal are rectangular-shaped columns 212 that cause water deposited at the top of the pedestal 216 to flow down the columns 212 and provide drips of water, which may be preferable by some animals.

The opening from the pedestal 216 may be configured to allow water to exit to an elevation greater than the height of the dome 214 and columns 212, creating a vertical or angled stream, from which an animal could drink directly. The shape of the dome 214 or columns 211 may be configured to provide several types of different amounts and types of falling water, and/or combinations of sheets of water or individual drops, depending on the preferences of a particular animal.

The pedestal 21 is shown in FIG. 8 as a tube embedded within column 212. However, the pedestal 216 may be a standalone piece disposed between two separate column members 212. In this configuration the columns may be removed or modifiable to change the drip or water distribution exiting the pedestal 216. The columns 212, when installed, may serve to support the pedestal and prevent an animal from knocking over the pedestal.

Vertical columns 212 may also comprise a cooling section 222 comprised of water absorbing material that functions to cool the water due to the cooling effect of evaporation. The pedestal 216 may be straight and vertical or coiled and raising vertically. The pedestal 216 is preferably made of a material that easily transmits and transfers the cooling effect of the water being evaporated from the water absorbing material that surrounds the columns 212.

The pedestal 216 may keeps its position by virtue of being made of a heavy material, or may be attached to the basin 210 with glue or screws or other means to fasten without harming the purity of the water.

The treatment unit 240 comprises a pump 234 and sterilization unit 232 that distribute and purify water in the system 200. A series macro and micro filters 230 may be provided so that the water that re-enters the basin 210 is free of any foreign or disease producing organism or substance, and may be located in between such components such as the basin 210, the pump 230, and the sterilization unit 232 and downstream from the sterilizer. The filters 230 are preferably configured to capture debris or organisms that are greater than 0.2 micron in size, and may also be employed and configured to remove some metals that are undesirable, such as mercury or lead.

The sterilization unit 232 preferably comprises a UV sterilizer as described above, but may also comprise any sterilizer described herein or available in the art.

The pump 234 may be separate from the basin 210, or in the basin, and either totally or partially covered by the water in the basin.

As shown in FIGS. 8 and 9, treatment unit 240 may be located outside of the basin 210 so as to not generate heat that would be transmitted into the water in the basin. Alternatively, treatment unit may be located inside a cabinet, as shown in FIGS. 1-3, for aesthetics, or to minimize exposure. The tubing from intake line 220 generally rests below the water line within the basin 210 and extends to the first macro filter 230 of the treatment unit 240. Beyond the macro filter 230, water may than pass through a micro filter (not shown) that will filter out very small objects so as not to harm the pump 234. Another micro filter 230 may be located downstream from the pump 234. The UV sterilization unit 232 may be in fluid communication with filter 230, or directly to the pump 234. Another micro filter 230 may be used downstream from the sterilizer, so that any organisms that were killed in the sterilization unit, e.g. cellular debris, are removed. The sterile and ultra pure water leaving the last micro filter 230 can either enter the basin with a length of tubing that lies inside the basin or can be attached to the bottom of the pedestal 216.

The basin 210 functions to hold water for an animal to drink from, as well as provide a base that is difficult to tip over or move in a way that causes spillage. The basin 210 may comprise a material that transfers heat from the water to the ambient room air, as described in the embodiments above. Inversely, the basin 210 may be insulated to keep the cool water contained in the basin from being heated from the ambient room air. The basin may have holes the walls or the bottom that would allow the passage of tubing (e.g. line 150) for the outflow or inflow of water from the pump and sterilizing and filtering units. The basin 210 may be of any shape that allows adequate water to be available an extended period of time. The basin 210 may be of a shape or depth that allows the component parts to be included within the basin.

The shape of the tubing or piping may be circular, elliptical, rectangular, or any other configuration to allow a greater surface area to accelerate the transport of heat or cooling factors via passive or mechanical means to attain a different temperature. Certain sections of the tubing or pipes could be made of a rigid material such as ceramic or other heat transferring material. The tubing may be made with plastic, wood, or any other material and may be one continuous piece or any number of pieces made with one or more different materials to retard or accelerate the dispersion of heat.

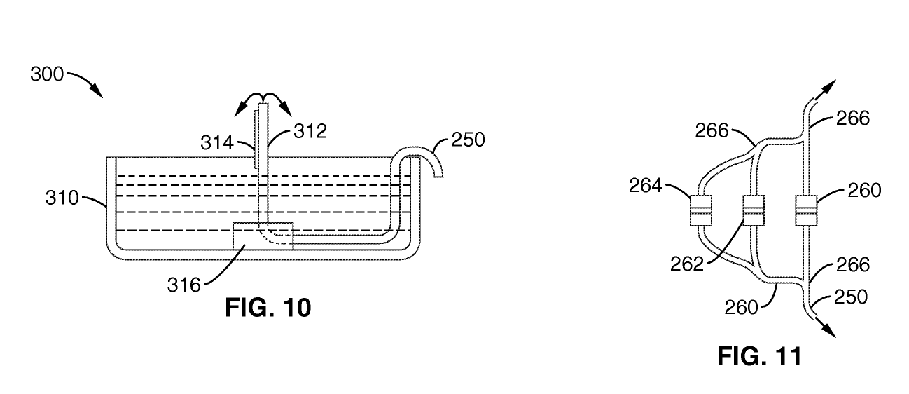

FIG. 10 illustrates yet another embodiment of a pet watering system 300. In this embodiment, tubing 250 is directed from water treatment unit 240 (as shown in FIG. 9) into pedestal 312, which is centrally located within basin 310. Pedestal 312 is vertically oriented upward from the bottom of basin 310 and directs water in a fountain-like manner upward and outward into basin 310. Cooling element 314 may also be coupled to pedestal 314 to facilitate cooling of the water.

FIG. 11 illustrates a filter overflow scheme that may be utilized with any of the filters used in the various embodiments of the present invention disclosed above. Incoming water from line 250 is directed into first filter 260 via junction 266. Under normal operation, water passes through filter 260 and output to the pump or sterilization unit. If first filter 260 is obstructed or clogged, the water will bypass to filter 262 and will be directed back to the same output via another junction 266 at the output. A third filter 264 may also be set up in a similar fashion to bypass the first and second filters if obstructed.

It is appreciated that each of the elements of the multiple embodiments listed above may be used interchangeably, where appropriate, in different embodiments than where the element is illustrated in FIGS. 1-11. Thus, no one embodiment shall be limited strictly to the elements described, but may be used in combination with other embodiments to meet the objectives of the present invention.

Although the description above contains many details, these should not be construed as limiting the scope of the invention but as merely providing illustrations of some of the presently preferred embodiments of this invention.

Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A pet watering apparatus, comprising:
a basin configured to hold a volume of drinking water;
a pump in fluid communication with the basin via an intake;
a sterilization unit in fluid communication with said pump;
said sterilization unit configured to kill organisms in the water;
a filter coupled to the sterilization unit and pump;
the filter configured to screen particles from the water; and
an outlet disposed above the basin for directing said filtered and sterilized water into the basin.

2. An apparatus as recited in claim 1, wherein the basin comprises a bowl-shaped receptacle having elevated sidewalls that cool the basin via surface water evaporation.

3. An apparatus as recited in claim 2, further comprising:
a base configured to house the basin, pump and sterilization unit;
wherein the basin is configured to be detachably removed from the base.

4. An apparatus as recited in claim 3:
wherein the sidewalls of the basin terminate at a lip formed around the circumference of the basin; and
wherein the lip rests on an opening in the base.

5. An apparatus as recited in claim 3, wherein the basin has an uninterrupted inner surface.

6. An apparatus as recited in claim 1, further comprising:
an intake filter at or near the intake;
said intake filter configured to screen the water from particulates prior to entering the pump.

7. An apparatus as recited in claim 1, further comprising:
an elevated container supported above the basin;
the elevated container configured to support a volume of water;
wherein the outlet is directed into the elevated container to at least partially fill the elevated container with water; and
a spout located near the bottom surface of the elevated container;
wherein the spout is configured to direct water into the basin.

8. An apparatus as recited in claim 7, wherein the elevated container comprises a porous material that absorbs water from an inside surface of the container to cool the container, thereby cooling the water in the container.

9. An apparatus as recited in claim 7:
wherein the elevated container is configured to house the filter at a location toward the bottom surface of the container; and
wherein water entering from the outlet passes through the filter before exiting out the spout.

10. An apparatus as recited in claim 7,
wherein the spout is adjustable to vary the direction and rate of water entering the basin.

11. An apparatus as recited in claim 1, wherein the sterilizer comprises a UV lamp configured to direct UV light at water distributed from said pump.

12. An apparatus as recited in claim 1, wherein the basin comprises an inner surface coated with an antimicrobial solution, said solution configured to sterilize said water.

13. A method for providing drinking water to an animal, comprising:
dispensing a volume of water in a basin configured to retain said water;
displacing at least a portion of the volume of water out of the pump via an intake line;
sterilizing the water; and
redirecting the water into the basin.

14. A method as recited in claim 13, further comprising:
filtering particulates from the water.

15. A method as recited in claim 13, wherein said filtering is performed at said intake.

16. A method as recited in claim 15, further comprising:
filtering said water after said sterilization of the water.

17. A method as recited in claim 15, wherein displacing at least a portion of the volume of water comprises generating a negative pressure at the intake via a pump in communication with the intake.

18. A method as recited in claim 13, further comprising:
elevating the water to a container above the basin;
filtering the water as it passes through the container; and
directing the water into the basin via a spout in the container.

19. A method as recited in claim 18, wherein directing the water into the basin comprises:
manipulating the spout to change the direction or flow of water into the basin.

20. A method as recited in claim 19, wherein the spout is manipulated to create a jet of water into the basin.

21. A method as recited in claim 20, wherein the spout is further manipulated to drip the water into the basin.

22. A method as recited in claim 18, further comprising:
cooling the volume of water retained in said basin.

23. A method as recited in claim 22, wherein said water is cooled from evaporative cooling of said basin.

24. A method as recited in claim 22, wherein said water is cooled from evaporative cooling of said elevated container.

25. A method as recited in claim 13, wherein sterilizing the water comprises passing UV light through the water.

26. A method as recited in claim 13, wherein sterilizing the water comprises subjecting the water to an antimicrobial solution disposed on the inner surface of the basin.

27. A system for providing drinking water to animals, comprising:
a basin configured to hold a volume of drinking water;
a water treatment module configured to treat said volume of water for consumption and circulate said water in and out of said basin; and
a base configured to house said water treatment module and basin;
wherein said basin is detachably received on said base.

28. A system as recited in claim 27, wherein the sidewalls of the basin form a lip formed around the circumference of the basin; and
wherein the lip rests on an opening in the base.

29. A system as recited in claim 28, wherein the basin has an uninterrupted inner surface.

30. A system as recited in claim 27, wherein the water treatment module comprises a sterilization unit configured to kill organisms present in the volume of water.

31. A system as recited in claim 30, wherein the sterilizer comprises a UV lamp configured to direct UV light at water distributed from said pump.

32. A system as recited in claim 27, wherein the basin comprises an inner surface coated with an antimicrobial solution, said solution configured to sterilize said water.

33. A system as recited in claim 30:
wherein the water treatment module comprises a pump coupled to the a sterilization unit; and
wherein the pump is configured to draw water in from an intake at the basin and circulate the water between the basin and the sterilization unit.

34. A system as recited in claim 33:
wherein the water treatment module comprises a filtration unit coupled to the pump and the a sterilization unit;
wherein the filter is configured to filter particulates from the volume of water.

35. A system as recited in claim 34, wherein the filtration unit comprises an intake filter at or near the intake;
said intake filter configured to screen the water from particulates prior to entering the pump.

36. A system as recited in claim 27, further comprising:
an elevated container supported above the basin;
the elevated container configured to support a volume of water supplied from the water treatment module to at least partially fill the elevated container with water; and
a spout located near the bottom surface of the elevated container;
wherein the spout is configured to direct water into the basin.

37. A system as recited in claim 36:
wherein the elevated container is configured to house a filter at a location toward the bottom surface of the container; and
wherein water entering from the outlet passes through the filter before exiting out the spout.

38. A system as recited in claim 36;
wherein the spout is adjustable to vary the direction and rate of water entering the basin.

39. A system as recited in claim 35, wherein the intake filter comprises a material that provides visual indication of the condition of the filter.
